(19) United States
(12) Patent Application Publication
(10) Pub. No.: US 2025/0074062 A1
(43) Pub. Date: Mar. 6, 2025

(54) RECORDING APPARATUS AND WIPING METHOD

(71) Applicant: CANON KABUSHIKI KAISHA, Tokyo (JP)

(72) Inventor: SHINJI KISHIKAWA, Tokyo (JP)

(21) Appl. No.: 18/817,085

(22) Filed: Aug. 27, 2024

(30) Foreign Application Priority Data
Aug. 31, 2023 (JP) 2023-141712

(51) Int. Cl. B41J 2/165; B41J 2/21; B41J 29/38

(52) U.S. Cl. CPC B41J 2/16508; B41J 2/21; B41J 29/38; B41J 2002/16594; B41P 2235/242; B41P 2235/244

(57) ABSTRACT

A recording apparatus includes a recording unit; a wiping unit configured to wipe the discharge port surface; at least one memory storing instructions; and at least one processor that is in communication with the at least one memory and that, when executing the instructions, cooperates with the at least one memory to perform control to cause the wiping unit to perform a wiping operation for wiping the discharge port surface, and then cause the wiping unit to feed the wiping member to enable wiping with a new region of the wiping member in a next wiping operation, acquire information about a discharge amount for each discharge port array, and determine a feed amount for feeding the wiping member after the wiping operation, based on the information about the discharge amount.

### BACKGROUND

### Field of the Disclosure

The present disclosure relates to a recording apparatus and a wiping method.

### Description of the Related Art

Japanese Patent Laid-Open No. 2020-138509 discusses a wiping technique for pressing a sheet-like wiping member onto a discharge port surface to remove a sticking substance, such as ink, on the discharge port surface of a recording head with ink discharge ports formed thereon. After wiping, the disclosed technique feeds the wiping member by a fixed amount so that a clean surface of the cleaning member is used for the next wiping.

### SUMMARY

According to an aspect of the present disclosure, a recording apparatus includes a recording unit having a discharge port surface having a plurality of discharge port arrays each including a plurality of discharge ports for discharging ink, a wiping unit including a sheet-like wiping member for wiping the discharge port surface, and configured to wipe the discharge port surface, at least one memory storing instructions, and at least one processor that is in communication with the at least one memory. When executing the instructions, the at least one processor cooperates with the at least one memory to perform control to relatively move the wiping unit and the recording unit in an arrangement direction of the discharge port arrays, cause the wiping unit to perform a wiping operation for wiping the discharge port surface, and then cause the wiping unit to feed the wiping member to enable wiping with a new region of the wiping member in a next wiping operation, acquire information about a discharge amount for each discharge port array, and determine a feed amount for feeding the wiping member after the wiping operation, based on the information about the discharge amount.

Further features of various embodiments will become apparent from the following description of exemplary embodiments with reference to the attached drawings.

### BRIEF DESCRIPTION OF THE DRAWINGS

FIG. 1 is a schematic view illustrating a configuration inside a recording apparatus according to an exemplary embodiment.

FIGS. 2A and 2B are schematic views illustrating a main configuration of the recording apparatus according to an exemplary embodiment.

FIG. 3 is a perspective view illustrating a recording head according to an exemplary embodiment.

FIG. 4 illustrates moving regions of a recording head and a wiping unit according to an exemplary embodiment.

FIG. 5 is a schematic view illustrating a configuration of the wiping unit according to an exemplary embodiment.

FIG. 6 is a block diagram illustrating a configuration of a control system of the recording apparatus according to an exemplary embodiment.

FIGS. 7A to 7E illustrate a wiping operation according to an exemplary embodiment.

FIGS. 8A to 8F are schematic views illustrating the upper surface of a wiping member during a wiping operation according to a first exemplary embodiment.

FIG. 9 is a flowchart illustrating the wiping operation according to the first exemplary embodiment.

FIG. 10 illustrates formulas for associating a count of the number of droplets and the amount of ink adhesion to a sheet according to the first exemplary embodiment.

FIG. 11 is a table illustrating the droplet adhesion amount according to the first exemplary embodiment.

FIGS. 12A and 12B are schematic views illustrating the upper surface of the wiping member during a wiping operation according to a comparative example.

FIGS. 13A to 13D are schematic views illustrating the upper surface of the wiping member during a wiping operation according to a second exemplary embodiment.

FIG. 14 is a flowchart illustrating the wiping operation according to the second exemplary embodiment.

FIGS. 15A to 15C are schematic views illustrating panel display according to a third exemplary embodiment.

### DESCRIPTION OF THE EMBODIMENTS

A recording apparatus according to an exemplary embodiment will be described in detail below with reference to the accompanying drawings. The following exemplary embodiments do not limit every embodiment. Not all of the combinations of the features described in the exemplary embodiments are indispensable to the solutions for the present disclosure. Positions and shapes of components described in the following exemplary embodiments are to be considered as illustrative and not restrictive on the scope of every embodiment of the present disclosure.

According to the present specification, “recording” includes not only forming texts, drawings, and other meaningful information but also forming meaningless information. “Recording” does not matter whether or not the outcome is actualized to be perceived by the human visual sense. “Recording” also refers to forming images, designs, and patterns on diverse types of recording media, and processing such media. “Recording media” refers to not only paper used for common recording apparatuses but also cloths, plastic films, metal plates, glasses, ceramics, woods, leathers, and other diverse types of ink-receptible media. Further, “ink” (also referred to as a “liquid” according to the present specification) is to be widely interpreted, like the above-described definition of “recording”. More specifically, “ink” refers to a liquid to be applied in process on a recording medium aiming for forming images, designs, and patterns, processing of the recording medium, and in processing of ink (coagulation or insolubilization of coloring materials in ink to be applied to the recording medium). Unless otherwise noted, “nozzles” collectively refer to discharge ports, flow paths communicating therewith, and elements for generating energy used to discharge ink.

Initially, a first exemplary embodiment of the present disclosure will be described. A recording apparatus according to a first exemplary embodiment will be described below. A recording apparatus according to the present specification is a serial scan type ink-jet recording apparatus that discharges ink onto a recording medium being conveyed while moving a recording head in a direction intersecting with the conveyance direction (a direction orthogonal to the conveyance direction in the present exemplary embodiment). The present specification uses three different directions (X, Y, and Z directions) orthogonally intersecting with one another.

### <Configuration of Recording Apparatus>

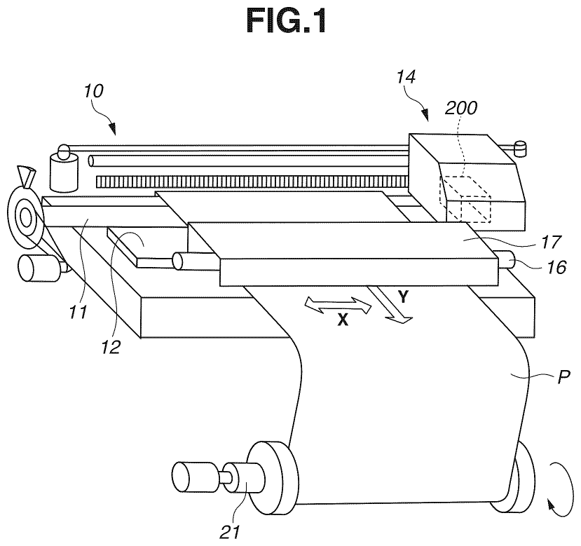

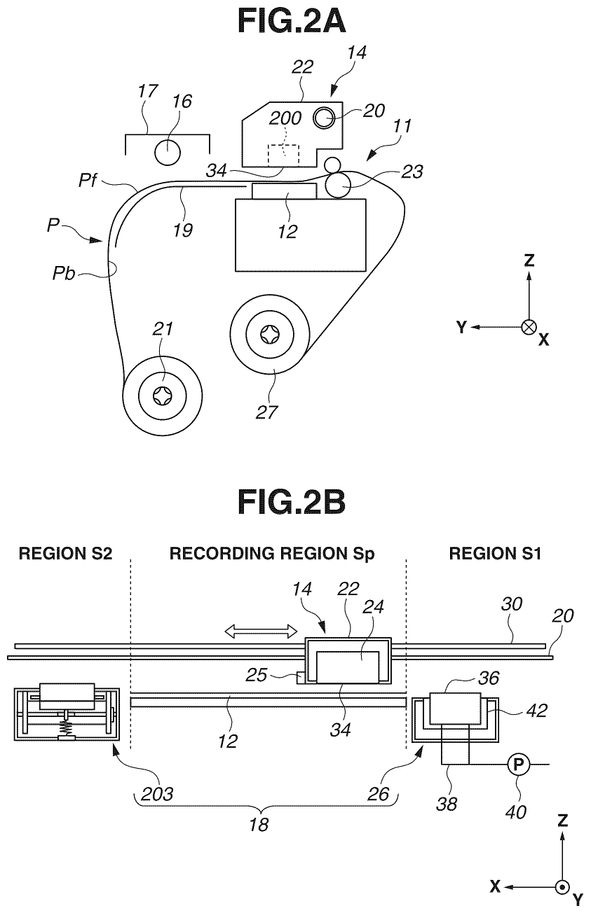

FIG. 1 is a schematic view illustrating a recording apparatus 10. FIG. 2A illustrates a heating unit in the recording apparatus 10, and FIG. 2B illustrates a recovery unit in the recording apparatus 10.

The recording apparatus 10 includes a platen 12 for supporting a recording medium P conveyed by a conveyance unit 11, and a recording unit 14 including a recording head 200 for recording an image on the recording medium P supported by the platen 12. The recording head 200 is not necessarily to be an image recording head and a liquid discharge head for discharging a liquid is sufficient. The recording apparatus 10 includes a heating unit 16 for heating a recording surface Pf of the recording medium P after recording, and a recovery unit 18 (see FIG. 2B) for favorably maintaining and recovering the ink discharge condition of the recording unit 14. The overall operation of the recording apparatus 10 is controlled by a control unit 600 (described below). While the present exemplary embodiment includes one control unit, two or more separate control units may be included.

In the conveyance unit 11, a conveyance roller 23 driven by a conveyance motor (not illustrated) via a gear conveys a sheet-like recording medium released and fed from roll paper 27 to the platen 12. The recording medium P after recording is rewound by a spool 21. The conveyance mechanism of the conveyance unit 11 is not limited thereto but various known techniques are applicable.

The recording unit 14 includes a carriage 22 movably attached to a guide shaft 20, and a recording head 200 that is attachable to and detachable from the carriage 22 and configured to discharge ink to the recording medium P supported by the platen 12 (see FIG. 2A). The guide shaft 20 extends in the X direction intersecting with the Y direction (the direction orthogonal to the Y direction in the present exemplary embodiment) in which the recording medium P is conveyed. The carriage 22 is reciprocally movable in the X direction along the guide shaft 20. The recording head 200 includes a plurality of discharge port arrays 302 (described below) each including a plurality of discharge ports for discharging ink arranged along the Y direction. A discharge port surface 34 (see FIG. 2A) with the discharge port arrays 302 formed thereon is attached to the carriage 22 to face the platen 12. Thus, the recording apparatus 10 enables the recording head 200 to discharge ink while reciprocally moving in the X direction. As a specific moving mechanism of the carriage 22, various known techniques are applicable. Examples of such techniques include a mechanism using a carriage belt for transmitting the driving force from a carriage motor, or a lead screw.

The recording apparatus 10 includes a scale 30 that has slits formed thereon at regular intervals in the X direction and extends in the X direction. The carriage 22 includes a linear encoder (not illustrated) for reading the scale 30. The linear encoder outputs a signal based on a reading result of the scale 30 to the control unit 600. The control unit 600 acquires the position of the recording head 200 based on this signal and controls the movement of the recording head 200. The recording head 200 is configured to discharge a plurality of types of ink. According to the present exemplary embodiment, black (K), cyan (C), magenta (M), and yellow (Y) inks are discharged from the recording head 200. The types of ink to be discharged by the recording head 200 are not limited thereto, and the number of ink types is not limited to four.

With the recording apparatus 10, the recording unit 14, specifically, the recording head 200 moves, for example, at a speed of 40 inches/sec. and performs recording with a resolution of 1200 dots per inch (dpi) (=1 dot for 1/1200 inch). When recording is started, the recording apparatus 10 moves the recording head 200 to a recording start position and the conveyance unit 11 conveys the recording medium P to a position at which the recording head 200 is able to perform recording. The recording apparatus 10 then performs a recording operation for discharging ink while moving (scanning) the recording head 200 in the X direction based on recording data. In response to completion of the recording operation, the conveyance unit 11 performs a conveyance operation for conveying the recording medium P by a predetermined amount. The recording apparatus 10 then performs the recording operation again. In this way, the recording apparatus 10 repeats the recording and the conveyance operations in alternation to record an image on the recording medium P. According to the present exemplary embodiment, the recording apparatus 10 performs, for example, multi-path recording by scanning the recording unit 14 a plurality of times for unit regions on the recording medium P.

The carriage 22 includes, on one side or the other side thereof in the X direction, a sensor 25 for detecting the density or lightness of ink adhering to an object at a position facing the discharge port surface 202 of the recording head 200. The sensor 25 serves as an optical sensor, emits light from the light-emitting portion to an object, receives the light through the light-receiving portion, and outputs the amount of the received light to the control unit 600. The control unit 600 detects the density or lightness of ink based on the amount of the received light. According to the present exemplary embodiment, the sensor 25 detects the density of ink adhering to a wiping member 204 (described below) of a wiping unit 203 (described below) of the recovery unit 18, which will be described in detail below. The sensor 25 is used to detect an edge of the recording medium P conveyed onto the platen 12 and measure an attribute, such as the distance between the recording medium P and the recording head 200. The sensor 25 may be configured to detect ink adhering to the wiping member 204 of the wiping unit 203.

The heating unit 16 irradiates a recording surface Pf of the recording medium P having been subjected to recording with heat to heat the recording surface Pf and ink discharged onto the recording surface Pf, thus fixing the ink to the recording surface Pf. The heating unit 16 is covered by a cover 17 having a function of efficiently reflecting the heat of the heating unit 16 onto the recording medium P, and a function of protecting the heating unit 16. Examples of usable heating units 16 include a sheathed heater, a halogen heater, and other various types of heaters. The heating unit 16 is not limited to these non-contact thermal conduction heaters but may be configured to heat using hot air. The heating unit 16 is configured to fix ink onto the recording medium P, so that the recording apparatus 10 may exclude the heating unit 16 depending on the ink types to be used. Although not illustrated, the recording apparatus 10 may include a cutter for cutting the recording medium P at a predetermined position.

The recovery unit 18 includes an absorption unit 26 disposed at the position adjacent to one end on one side (first side) of the platen 12 in the X direction, and the wiping unit 203 disposed at the position adjacent to the other end on the other side (second side) of the platen 12 in the X direction. More specifically, the absorption unit 26 is disposed in a region S1 on one end side of a recording region Sp where the recording head 200 performs recording on the recording medium P supported by the platen 12. The wiping unit 203 is disposed in a region S2 on the other end side of the recording region Sp. The configuration of the wiping unit 203 will be described in detail below.

The absorption unit 26 is configured to forcibly absorb ink from the plurality of discharge ports configuring the discharge port arrays 302 on the recording head 200 to favorably maintain and recover the ink discharge performance of each discharge port. The absorption unit 26 is provided with a cap 36 for covering a predetermined region including the discharge port arrays 302 on the discharge port surface 202 of the recording head 200. More specifically, the cap 36 covers the discharge port arrays of the K ink, the discharge port arrays of the C ink, the discharge port arrays of the M ink, and the discharge port arrays of the Y ink. The cap 36 may be independently configured for each ink color.

The cap 36 is connected to a pump 40 via tubes 38. In a state where the cap 36 is brought into contact with the discharge port surface 202 to cover a predetermined region including the discharge port arrays 302, the pump 40 connected to the cap 36 produces a negative pressure in the cap 36, and this negative pressure causes ink to be forcibly absorbed from the discharge ports by the negative pressure. The cap 36 is movable in the Z direction by an elevating and lowering unit 42. When the cap 36 is raised by an elevating and lowering unit 42, the cap 36 comes into contact with the discharge port surface 202 to cover the predetermined region. When the cap 36 is lowered by the elevating and lowering unit 42, the cap 36 is separated from the discharge port surface 202 to release the predetermined region.

### <Configuration of Recording Head>

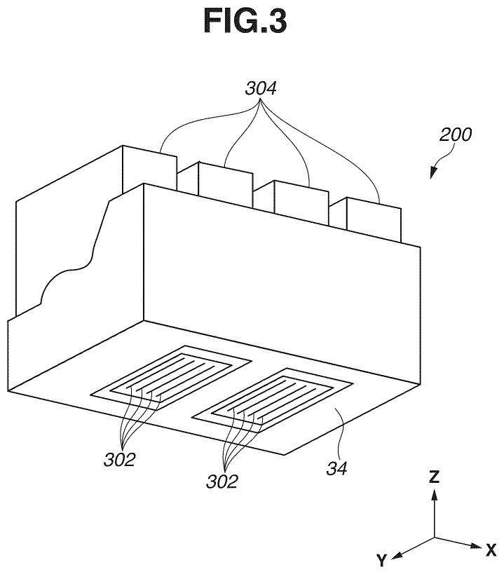

The configuration of the recording head 200 will be described below. FIG. 3 is a schematic view illustrating the recording head 200. For each ink color, the discharge port surface 202 of the recording head 200 includes the discharge port arrays 302 formed of the plurality of discharge ports for discharging inks of different colors. The discharge port arrays 302 extend in the Y direction, and the discharge port arrays 302 corresponding to different color inks are adjacently disposed along the X direction.

According to the present exemplary embodiment, the discharge port arrays 302 include 1,280 discharge ports arranged along the Y direction with a density of 1,200 dpi. Each discharge port discharges an ink droplet amount of about 4.5 picoliter (pl) at a time. In a region of the discharge port surface 202 including the discharge port arrays 302, for example, a region including at least the predetermined region covered by the cap 36, a water-repellent film that rejects ink, in other words, has water repellency is formed to prevent ink droplet adhesion to the discharge ports. If ink droplet adhesion to the discharge ports is prevented by the water-repellent film, the discharge performance of the discharge slots is maintained stable. For example, the contact angle between the water-repellent film and ink is 80 degrees or more and 100 degrees or less. The contact angle refers to the angle (dynamic retreat contact angle) at which an ink droplet comes into contact with the water-repellent film. According to the present exemplary embodiment, the water repellency refers to a state where a portion in contact with ink droplets does not wet. The water repellency can be determined by measuring the contact angle (dynamic retreat contact angle) of ink droplets in contacted with the member surface.

Each discharge port is supplied with ink from a joint 304 connected with an ink tank (not illustrated) storing the corresponding ink via a supply tube (not illustrated) via an ink flow path (not illustrated) in the recording head 200. The recording head 200, a thermal ink-jet recording head for discharging ink by using thermal energy, includes a plurality of electrothermal conversion elements for generating thermal energy. More specifically, the recording head 200 generates thermal energy by using a pulse signal applied to the electrothermal conversion elements to bring about film boiling of inks in ink bubbling chambers (not illustrated) with this thermal energy, and discharges inks from the discharge ports by using the bubbling pressure of the film boiling. The ink discharge method is not limited thereto but may be other known methods including a method using a piezoelectric element.

The present exemplary embodiment will be described below using the carriage 22 including one recording head 200 as an example. The carriage 22 may include a plurality of the recording heads 200. The inks to be supplied from the ink tanks mounted in the main body or in an external unit are supplied to the recording head 200 via the supply tubes. The inks are supplied from the ink tanks to the recording head 200 via a pressurization unit. Alternatively, the discharge port surface 202 of the recording head 200 may be capped by the cap 36, a negative pressure may be applied to the inside of the cap 36 by the pump 40 to absorb inks, and inks may be supplied from the ink tanks to the recording head 200.

### <Wiping Unit>

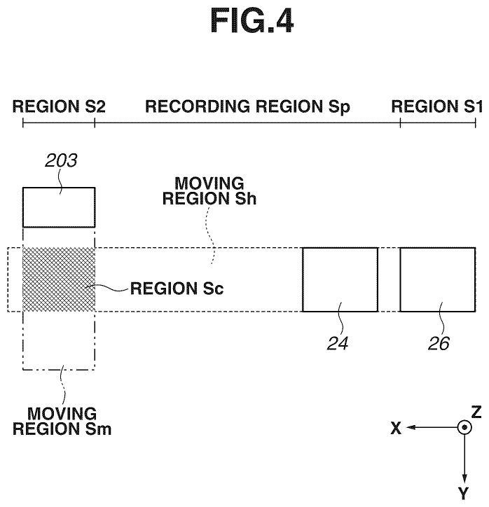

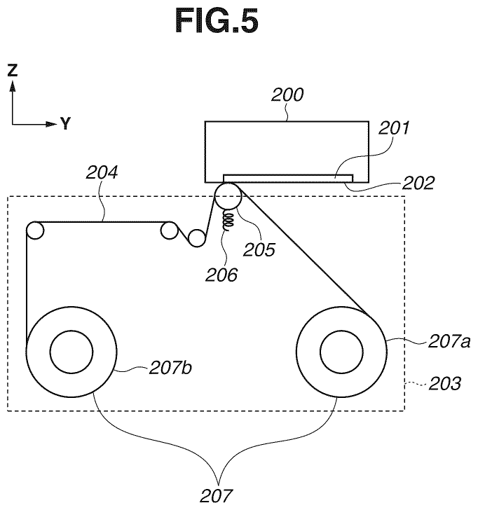

The configuration of the wiping unit 203 in the recovery unit 18 will be described below. FIG. 4 illustrates a moving region Sm of the wiping unit 203 and a moving region Sh of the recording head 200. FIG. 5 is a schematic lateral view illustrating a configuration of the wiping unit 203 when viewed from the second side in the X direction.

The wiping unit 203 is disposed to be movable in the Y direction in a region S2 facing the second side of the recording region Sp. The moving region Sm for the wiping unit 203 partly overlaps with the moving region Sh for the recording head 200 which moves in the X direction, as illustrated in FIG. 4. The wiping unit 203 is reciprocally movable between a first position located in the Y direction from the moving region Sh of the recording head 200 and a second position located in the −Y direction from the moving region Sh.

When the wiping operation is not operated, the wiping unit 203 is positioned, for example, at a waiting position that does not overlap with neither the moving region Sm for the wiping unit 203 nor the moving region Sh for the recording head 200. When the wiping operation is operated, the wiping unit 203 moves from a wiping start position to a wiping end position while the recording head 200 is positioned at the wiping position within a region Sc where the moving region Sm overlaps with the moving region Sh. The wiping start position is where the wiping unit 203 is positioned when wiping is started and is disposed on the first position side not overlapping with the region Sc. The wiping end position is where the wiping unit 203 is positioned when wiping is ended and is disposed on the second position side not overlapping with the region Sc. The first and the second positions may be on either the +Y or −Y side of the region Sc.

The wiping unit 203 includes a sheet-like wiping member 204 that receives ink during wiping and wipes ink that has touched and adhering to the discharge port surface 202 (see FIG. 5). The wiping unit 203 includes a winding unit 207 for winding the wiping member 204, and a pressing member 205 for pressing the wiping member 204 with a predetermined pressure to bring the winding wiping member 204 into contact with the discharge port surface 202.

The wiping member 204 is made of, for example, a porous material which facilitates absorbing inks from the discharge ports during wiping as compared with an elastic material. The wiping member 204 may be impregnated with an impregnating solution having a low-volatility solvent as the main ingredient, such as polyethylene glycol. For example, the wiping member 204 is made of a nonwoven fabric. More specifically, examples of desirably usable nonwoven fabrics include a sheet web and a pat-formed nonwoven fabric with which fibers are fusion-bonded, or combined or interwound through a mechanical or chemical action. The wiping member 204 can momentarily absorb liquid, such as adhering ink, by the capillary pressure by minute capillary in the nonwoven fabric. Examples of usable nonwoven fabrics include a nonwoven fabric made of a polyester staple fiber. The wiping member 204 may also be a sheet-like knit fabric or woven fabric made of a continuous fiber. Examples of usable materials include a mixture of polyester and nylon, and cotton.

The winding unit 207 includes a rotating member 207a with the unused wiping member 204 wound therearound, and a rotating member 207b for winding the used wiping member 204. The rotating member 207b is disposed on one side of the rotating member 207a in the Y direction. The tip of the wiping member 204 is attached to the rotating member 207b that rotates under the control of the control unit 600 to wind the wiping member 204. When the portion having wiped the recording head 200 is wound, the next wiping can be performed by using an unused clean portion of the wiping member 204.

The drive of the rotating member 207b is controlled, via, for example, gears, by the drive of the conveyance motor for driving the conveyance roller 23. Thus, the wiping member 204 positioned between the rotating members 207a and 207b is conveyed in the direction (−Y direction) opposite to the conveyance direction of the recording medium P. The conveyance amount of the wiping member 204 is not limited to being controlled by the drive amount of the conveyance motor. For example, the conveyance amount may be controlled based on a result of measurement performed by a component for measuring the conveyance amount of the wiping member 204.

The pressing member 205 presses, with the biasing force of a wiping unit spring 206, the wiping member 204 positioned over a range from the rotating member 207a to the rotating member 207b toward the upward side, between the rotating members 207a and 207b. The wiping unit spring 206 has a spring pressing force that changes according to the height of the recording head 200. Although the present exemplary embodiment uses a spring, other elastic members are also applicable. The pressing member 205 has an X-directional length L1 corresponding to the predetermined region on the discharge port surface 202 of the recording head 200 at the wiping position.

The X-directional length of the pressing region where the wiping member 204 is pressed by the pressing member 205 may be longer than the length corresponding to the predetermined region. For example, the length may cover the entire discharge port surface 202 of the recording head 200. In this case, adjusting the X-directional length of the wiping member 204 enables wiping the entire discharge port surface 202. Thus, when the predetermined region is capped by the cap 36, a gap is hardly formed between the cap 36 and the discharge port surface 202. For example, the pressing member 205 has a Y-directional length L2 of about 5 mm. This length allows the wiping member 204 pressed by the pressing member 205 to come into contact with about 240 discharge ports in the discharge port arrays 302 at the same time.

The recording head 200 includes an elevating and lowering unit (not illustrated). The elevating and lowering unit is operated under the control of the control unit 600 to change the distance to the wiping unit 203. When the wiping unit 203 wipes the discharge port surface 202 of the recording head 200, the recording head 200 is lowered. The form is not limited thereto. For example, the wiping unit 203 may include a lowering unit for lowering the pressing member 205. This lowering unit under the control of the control unit 600 lowers the pressing member 205 against the biasing force of the wiping unit spring 206. This allows the wiping unit 203 to move in the moving region Sm without bringing the discharge port surface 202 into contact with the wiping member 204. The wiping unit 203 may wipe the discharge port surface 202 by moving both the recording head 200 and the wiping unit 203. More specifically, in the recording apparatus 10, the recording head 200 and the wiping unit 203 are to be configured to relatively move in the arrangement direction of the discharge ports so that the discharge port surface 202 is wiped.

### <Configuration of Control System of Recording Apparatus>

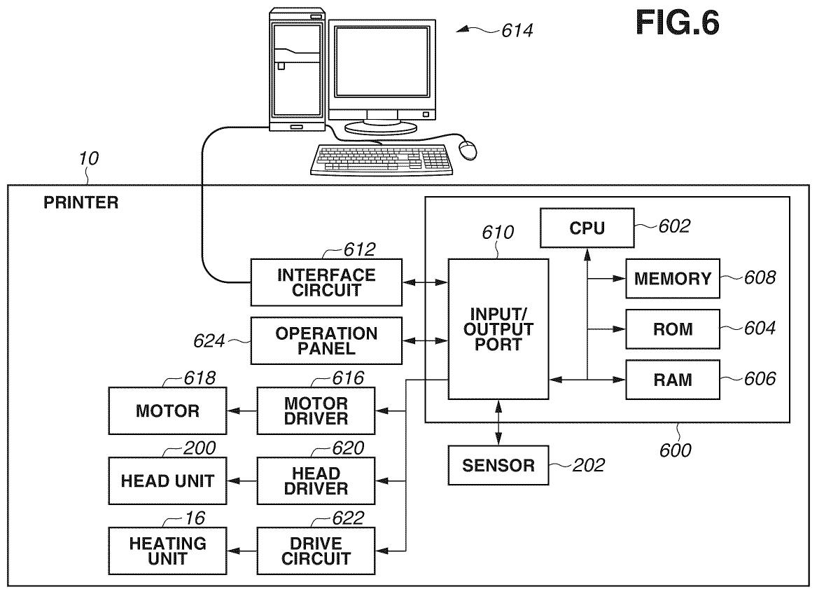

A configuration of the control system of the recording apparatus 10 will be described below. FIG. 6 is a block diagram illustrating the configuration of the control system of the recording apparatus 10.

The control unit 600 for controlling the entire recording apparatus 10 includes a central processing unit (CPU) 602, a read only memory (ROM) 604, a random access memory (RAM) 606, and a memory 608. The CPU 602 performs operation control for components in the recording apparatus 10 and processing for input image data based on various programs. The ROM 604 functions as a memory for storing various control programs and image data processing programs to be executed by the CPU 602. The RAM 606 is a memory for temporarily storing various data to be used to control the recording apparatus 10, and serves as a work area to be used by the CPU 602 to execute various processing. The memory 608 stores data such as counts to be used for wiping processing (described below). The control unit 600 including an input/output port 610 is connected with various drivers and drive circuits via the input/output port 610.

The control unit 600 is connected to an interface circuit 612 via the input/output port 610, and connected to a host apparatus 614 via the interface circuit 612. The control unit 600 is connected, via the input/output port 610, to an operation panel 624 which is operable by the user. The user inputs image data to the recording apparatus 10 via the host apparatus 614 and inputs various information to the recording apparatus 10 via the host apparatus 614 and the operation panel 624. The control unit 600 is connected to a motor driver 616 via the input/output port 610 to control the drive of a motor 618 via the motor driver 616. FIG. 6 illustrates various motors including the motor for moving the carriage 22, the motor for conveying the recording medium P, the motor for moving the wiping unit 203, the motor for driving the winding unit 207, and other motors. These motors in the recording apparatus 10 are collectively referred to as a motor 618.

The control unit 600 is connected to a head driver 620 via the input/output port 610 to control the recording head 200 via the head driver 620 to discharge ink. The control unit 600 is connected to a drive circuit 622 via the input/output port 610 to control the drive of the heating unit 16 via the drive circuit 622. The control unit 600 is further connected to the sensor 25 via the input/output port 610 to control the drive of the sensor 25 and receive a detection result from the sensor 25.

In the control unit 600, the CPU 602 converts image data input from the host apparatus 614 into record data, and stores the data in the RAM 606. More specifically, the CPU 602 acquires image data represented by 8-bit information (representing 0 to 255) for each of red (R), green (G), and blue (B). Then, the CPU 602 converts the image data into multi-valued data represented by a plurality of types of ink (K, C, M, and Y according to the present exemplary embodiment) to be used for recording. This color conversion processing generates multi-valued data represented by 8-bit information (representing 0 to 255) that define the gradations of the K, C, M, and Y inks in each pixel group including a plurality of pixels.

The multi-valued data represented by K, C, M, and Y is then quantized and quantization data (binary data) represented by 1-bit binary information (representing 0 and 1) defining discharge or non-discharge of the K, C, M, and Y inks for each pixel is generated. Examples of applicable quantization processing include various available quantization methods such as the error diffusion method, dither method, and index method. Subsequently, the quantization data is distributed for multiple scannings for unit regions of the recording head 200. This distribution processing generates recording data represented by the 1-bit binary information (representing 0 and 1) defining discharge or non-discharge of the K, C, M, and Y inks for each pixel in multiple scanning for unit regions of the recording medium P. This distribution processing corresponds to multiple scanning, and is executed by using a mask pattern for defining the permission or inhibition of ink discharge for each pixel. Such recording data may be executed not only by the control unit 600 but also by the host apparatus 614. Alternatively, part of the processing may be executed by the host apparatus 614 and the remaining processing may be executed by the control unit 600.

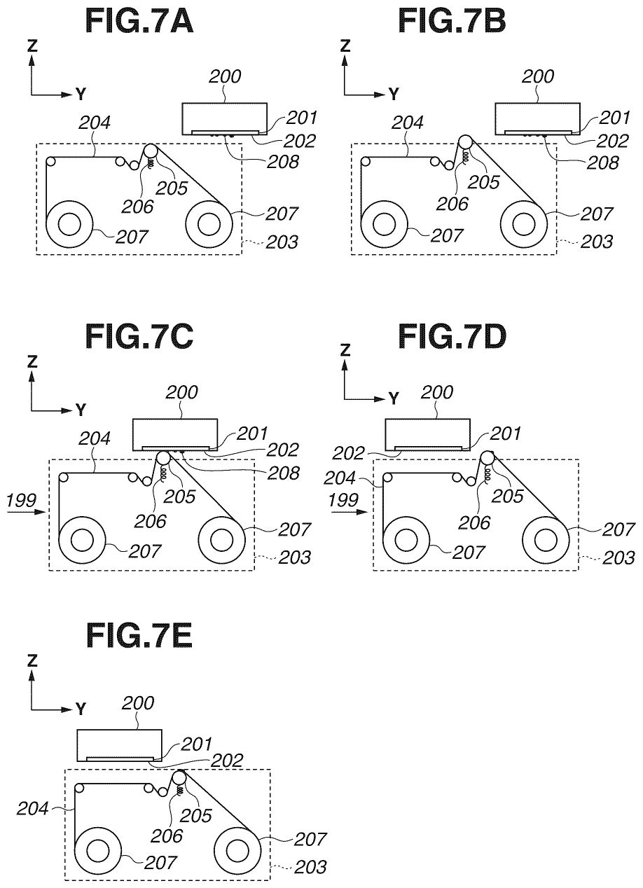

FIGS. 7A to 7D are schematic cross-sectional views illustrating the positional relation between the wiping unit 203 and the recording head 200 during the wiping operation.

FIG. 7A illustrates the positional relation between the wiping unit 203 and the recording head 200 before the wiping operation. In the positional relation, the recording head 200 and the wiping unit 203 are movable in the Y direction without being in contact with each other. FIG. 7B illustrates a state where the pressing member 205 is upwardly moved in the Z direction to prepare for the wiping operation. In the state in FIG. 7B, if the wiping unit 203 is moved in the Y direction, the pressing region on the wiping member 204 pressed by the pressing member 205 can come into contact with the discharge port surface 202 of the recording head 200. FIG. 7C illustrates a state where the wiping unit 203 is moved in the Y direction (arrow 199), and the pressing region on the wiping member 204 pressed by the pressing member 205 comes into contact with the discharge port surface 202 of the recording head 200.

In this contact state, an ink sticking substance 208 adhering to the discharge port surface 202 can be absorbed within the pressing region on the wiping member 204 pressed by the pressing member 205. FIG. 7D illustrates a state where the wiping unit 203 is scanned in the Y direction to the wait position. Further, the wiping unit 203 can also be moved while the sheet winding unit 207 is winding the sheet. FIG. 7E illustrates a state where the pressing of the wiping unit spring 206 is released at the wait position, and the pressing member 205 is moved down in the Z direction. FIGS. 7A to 7E illustrate the sequence of a single wiping operation.

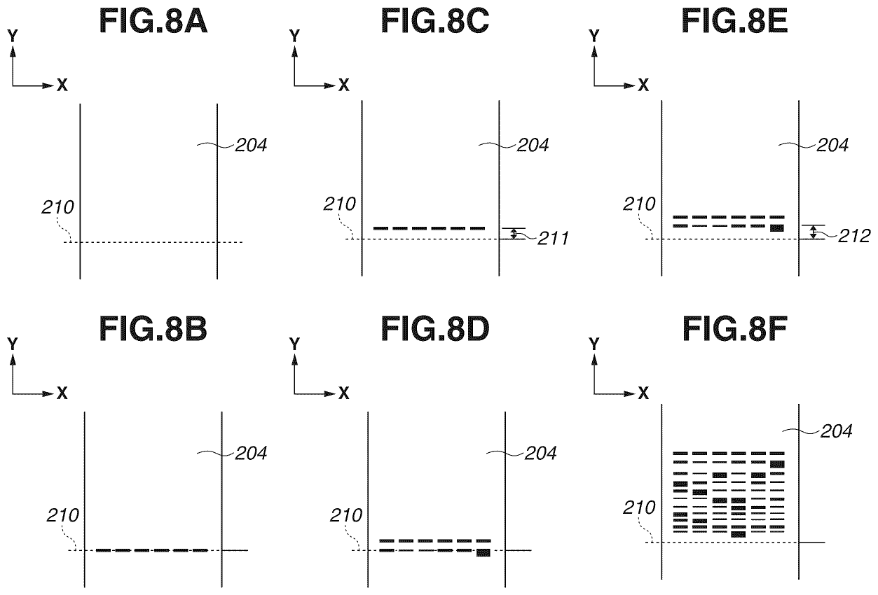

FIGS. 8A to 8F are schematic views illustrating the top surface of the wiping member (sheet) 204 during the wiping operation. FIG. 8A illustrates a state of a sheet 204 not having been subjected to the wiping operation. Since the sheet 204 has not been subjected to wiping, the entire surface has no ink adhesion and is clean. FIG. 8B illustrates a state of the sheet 204 having been once subjected to the wiping operation. Since wiping is performed at the position in contact with a wiping position 210, ink adhesion occurs at the wiping position 210. The CPU 602 determines a first feed amount 211 based on the value of the number of droplets counted before the first wiping, and performs the sheet feeding. FIG. 8C illustrates a state after the sheet feeding is performed.

FIG. 8D illustrates a state where the second wiping is performed. The largest ink adhesion region corresponds to the discharge port array having the largest number of droplets. The increase in the number of droplets increases the amount of ink adhesion to the surface of the recording head 200, result in an increase of the area of the ink adhesion region. FIG. 8E illustrates a state where a second feed amount 212 is determined based on the count of the number of droplets of the discharge port array having the largest number of droplets, and a sheet feeding is performed. The second feed amount 212 is larger than the first feed amount 211. FIG. 8F illustrates the surface of the sheet 204 after the wiping and feeding are repeated in a similar way. The sheet feed amount is changed according to the largest number of droplets.

The sheet feed amount is adjusted to secure a certain interspace between wiping operations. This adjustment is made so that the interspace absorbs mechanical accuracy variations in sheet feeding, enabling constant wiping of the discharge port surface 202 with a clean surface of the sheet 204. Thus, the interspace can be made smaller if a feed apparatus has smaller accuracy variations, and can be omitted if accuracy variations are almost zero.

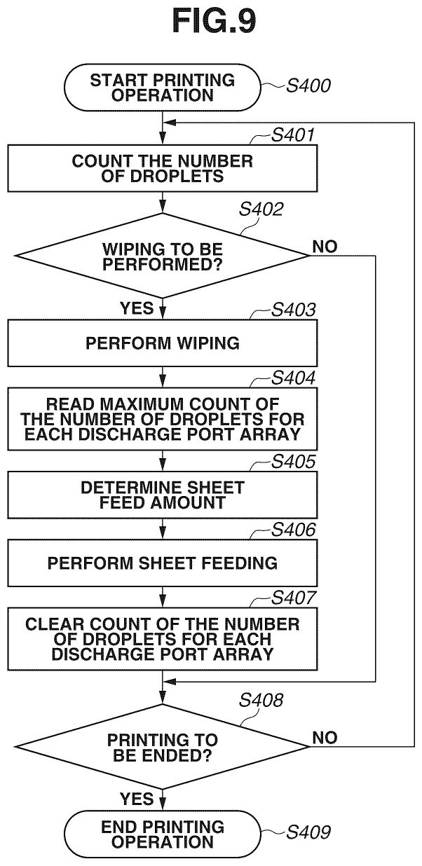

FIG. 9 is a flowchart illustrating the wiping operation. This flowchart is executed by the control unit 600 according to a program stored in the ROM 604. For example, the flowchart is started when the recording apparatus 10 receives a recording instruction from the user.

In step S400, the CPU 602 starts a print operation. In step S401, the CPU 602 counts the number of ink droplets for each discharge port array.

In step S402, the CPU 602 determines whether to perform the wiping operation. Examples of timings for starting the wiping include the timing when the number of droplets with which a discharge failure may possibly occur is reached and the timing when a predetermined number of print sheets is reached. According to the present exemplary embodiment, the CPU 602 determines the timing based on the number of droplets. The number of droplets for starting the wiping is preset and stored in the ROM 604. In step S402, the CPU 602 determines whether the number of droplets counted in step S401 is equal to or larger than the number of droplets stored in the ROM 604. If the number of droplets counted in step S401 is equal to or larger than the stored number of droplets (YES in step S402), the processing proceeds to step S403. If the number of droplets counted in step S401 is smaller than the stored number of droplets (NO in step S402), the processing proceeds to step S408.

In step S403, the CPU 602 performs the wiping. The movements of the wiping unit 203 and the recording head 200 are as described above in conjunction with FIGS. 8A to 8F. In step S404, the CPU 602 reads a maximum value of the number of droplets for each discharge port array counted in step S401. In step S405, the CPU 602 determines a sheet feed amount by using a formula or table for associating the read count with the size of the ink adhesion region and the number of droplets separately stored in the ROM 604. A formula or table for directly associating the sheet feed amount and the number of droplets may be stored in the ROM 604.

A clean surface of the sheet 204 is to be exposed to the pressing region, so that the sheet feed amount is to be larger than the size of the ink adhesion region. A formula or table for associating the count of the number of droplets with the ink adhesion amount includes the ink color, the time from discharge to wiping, and the influences of the humidity and temperature of the surrounding environment. Inks of different colors have different types and different amounts of ink pigment components, resin components, solvent components contained, exhibiting different viscosities and surface tensions. Generally, lower viscosities and surface tensions make discharged ink droplets less likely to be gathered, resulting in a larger amount of generated mist. The increase in an amount of mist increases an amount of ink adhesion to the liquid discharge face, thus increasing the amount of ink adhesion to the sheet surface during the wiping.

After determining the sheet feed amount in step S405, then in step S406, the CPU 602 performs the sheet feeding. Although the present exemplary embodiment performs the sheet feeding immediately after the wiping, the wiping may be performed immediately before the next wiping.

In step S407, the CPU 602 clears the count of the number of droplets for each discharge port array to match the adhesion state of the discharge port surface after the wiping with the state of the count of the number of droplets. In step S408, the CPU 602 determines whether printing is completed. If printing is not completed (NO in step S408), the processing returns to step S401. If printing is completed (YES in step S408), the processing proceeds to step S409. In step S409, the CPU 602 completes the print operation.

The wiping operation may also be performed in other than the print operation. For example, the wiping operation may be performed at the time of absorption recovery. The ink recovery refers to a sequence performed if ink cannot be discharged because of ink drying or thickening. In this sequence, the CPU 602 absorbs dried or thickened ink in the discharge ports to discharge the ink out of the discharge ports, enabling ink discharge from the discharge ports. Since the discharge port surface after the absorption recovery is stained by ink, the discharge port surface can be cleared through the wiping. In this case, the CPU 602 determines the sheet feed amount after the wiping by converting the absorption recovery time and absorption intensity into the number of droplets.

According to the present exemplary embodiment, the CPU 602 counts the number of droplets to determine whether to perform the wiping, any information about the discharge amount is applicable. For example, the CPU 602 may acquire the discharge amount itself and determine the sheet feed amount based on the discharge amount.

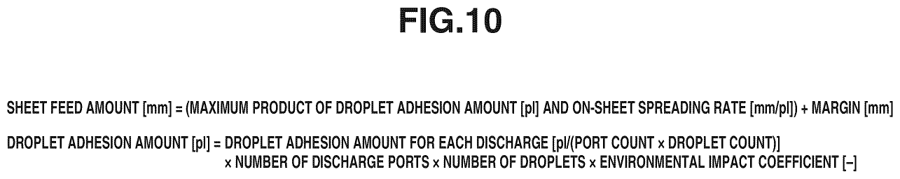

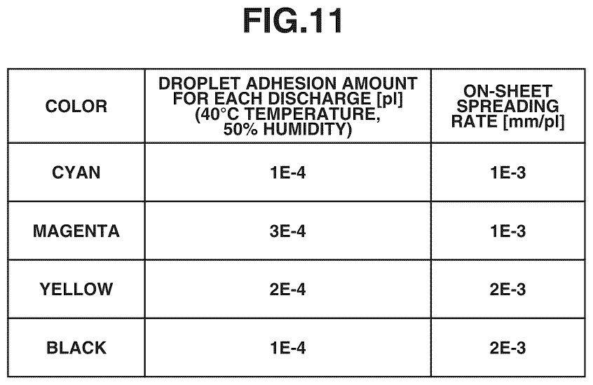

FIG. 10 illustrates a formula for associating the count of the number of droplets with the amount of ink adhesion to the sheet. The sheet feed amount is obtained by adding the margin to a maximum color value of the product of the amount of droplet adhesion to the sheet and the on-sheet spreading rate. The droplet adhesion amount includes the amount of ink adhesion to the liquid discharge face. FIG. 11 illustrates calculated values of the droplet adhesion amount and the on-sheet spreading rate.

According to the present exemplary embodiment, as illustrated in FIG. 11, the droplet adhesion amount per discharge is 1E-4 [pl] for cyan, 3E-4 [pl] for magenta, 2E-4 [pl] for yellow, and 1E-4 [pl] for black. The droplet adhesion amount per discharge is a value measured at an environmental temperature of 40° C. and an environmental humidity of 50%. After ink is discharged several times to allow ink adhesion to the discharge port surface, the amount of ink adhesion to the discharge port surface of the recording head 200 is obtained based on a change in weight of the recording medium with an image recorded thereon or the recording head 200. Then, the ink adhesion amount is divided by the number of droplets to obtain the droplet adhesion amount. In this case, the ink adhering to the discharge port surface of the recoding head 200 is entirely absorbed by the sheet in the wiping. The droplet adhesion amount for each color depends on the amounts of ink components such as the amount of solvent or pigment component contained.

The on-sheet spreading rate in FIG. 11 is represented by the distance [mm] over which 1 [pl] of adhering ink spreads on the sheet. According to the exemplary embodiment, the on-sheet spreading rate is 1E-3 [mm/pl] for cyan and magenta and 2E-3 [mm/pl] for yellow and black. The amount of ink spreading on the sheet also depends on ink components. For example, ink having a lower surface tension has a higher on-sheet spreading rate. Further, the on-sheet spreading rate also varies depending on the material of the sheet. For a nonwoven fabric sheet, the fiber has a net structure. A finer net provides a stronger capillary force for absorbing ink, and therefore allows ink to easily spread on the sheet. In a case where a solvent or moisturizing liquid is immersed in the sheet, the ink spread on the sheet increases with increasing solubility between the impregnant liquid and the ink.

Ink spreading on the sheet and the sheet feeding are performed based on the formulas in FIGS. 10 and the table in FIG. 11. For example, in a case of continuous printing, the numbers of droplets discharged before the wiping are as follows: 2E4 for cyan, 4E4 for magenta, 1E4 for yellow, and 1E4 for black. Setting is made to perform the wiping when the number of droplets reaches 4E4 for each array. The number of discharge ports is 512 for each array. Under an environmental temperature of 40° C. and an environmental humidity of 50%, the product of the liquid adhesion amount and the on-sheet spreading rate is maximized to 6.144 mm for magenta. With a margin of 1.0 mm, the sheet feed amount is obtained as 8.0 mm with a fraction rounded up. In a case of continuous printing after the wiping, the cumulative numbers of droplets discharged before the next wiping are as follows: 2E4 for cyan, 2E4 for magenta, 2E4 for yellow, and 2E4 for black. The number of discharge ports is 512 for each array. Under an environmental temperature of 40° C. and an environmental humidity of 50%, the product of the liquid adhesion amount and the on-sheet spreading rate is maximized to 4.096 mm for yellow. With a margin of 1 mm, the sheet feed amount is obtained as 6.0 mm with a fraction rounded up. As described above, the amount of feeding the sheet 204 is determined using the count of the number of droplets before the wiping, so that the sheet feed amount can be changed for each wiping. This enables constantly setting a clean sheet surface at the wiping position without an increase of the unused region of the sheet 204. The present exemplary embodiment makes it possible to, through wiping, remove the ink adhering to the discharge port surface which may cause a discharge failure, and to reduce the amount of sheet usage.

### COMPARATIVE EXAMPLES

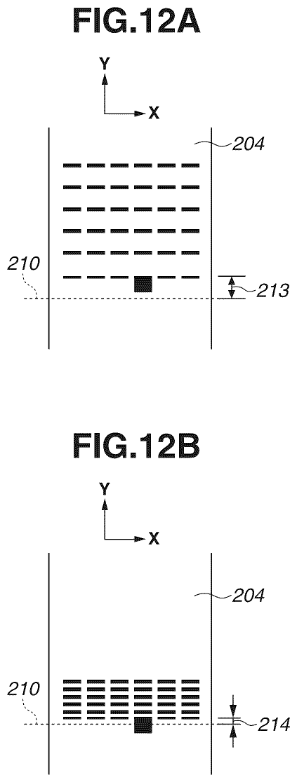

FIGS. 12A and 12B illustrate comparative examples. FIG. 12A illustrates the surface of the sheet 204 after the wiping in a case where a clean surface of the sheet 204 can be set at the wiping position even if the ink adhesion amount is maximized and where the feed amount of the sheet 204 is fixed to a maximum assumable feed amount 213. If the ink adhesion amount is large for a certain discharge port array, the sheet 204 is efficiently used. However, if there is almost no difference in the ink adhesion amount between discharge port arrays, the feed amount of the sheet 204 uselessly increases resulting in an increase in the area of the unused region of the sheet 204.

The CPU 602 calculates the sheet feed amount based on the formulas in FIG. 10 and the table in FIG. 11. If the number of droplets is the same for each color, the ink spreading on the sheet surface is maximized in the yellow array. More specifically, the number of droplets discharged immediately before the wiping is maximized to 4E4 for yellow, and the sheet feed amount is 10.0 mm including a margin of 1.0 mm. In this case, the sheet 204 is to be fed by a larger amount than in a case where the sheet feed amount is changed according to the number of droplets. This means a low sheet usage efficiency.

FIG. 12B illustrates the surface of the sheet 204 after the wiping in a case where the feed amount of the sheet 204 is fixed to a minimum assumable feed amount 214, with reference to a case of a small ink adhesion amount. If there is almost no difference in the ink adhesion amount between discharge port arrays, the feed amount of the sheet 204 is efficient, and a clean surface of the sheet 204 can be set at the wiping position. However, if the ink adhesion amount locally increases for a certain discharge port array, the feed amount of the sheet 204 becomes insufficient. In this case, the next wiping will be performed with a stained surface, possibly causing ink re-adhesion or damage to the discharge port surface. For example, the least sheet feed amount is 1.0 mm corresponding to the margin on the premise that ink is not discharged at all. However, if ink adhesion as illustrated in FIG. 12A occurs on the sheet 204, a feed amount of 1.0 mm does not enable setting a clean surface of the sheet 204 as the next wiping surface.

Thus, with a fixed feed amount, the unused region of the sheet 204 increases or the sheet feed amount becomes insufficient, making it impossible to perform the optimum sheet feeding.

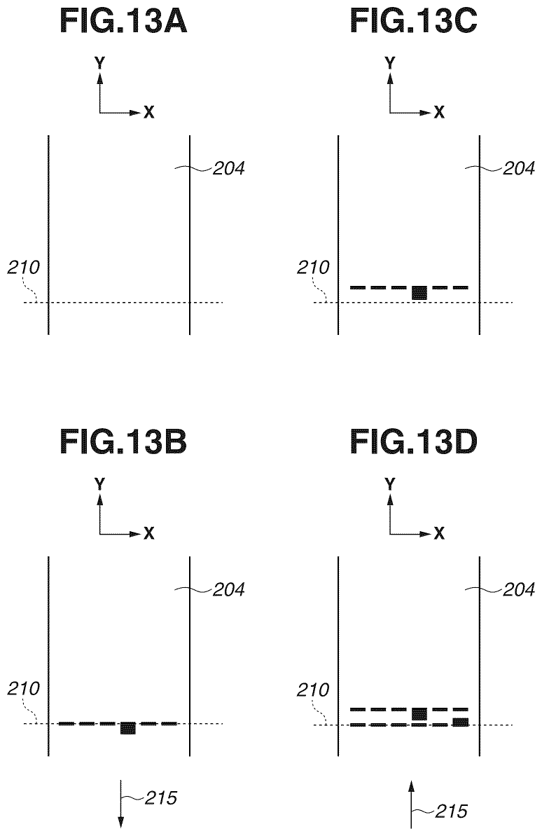

A second exemplary embodiment of the present disclosure will be described below. FIGS. 13A to 13D illustrate a wiping operation according to the second exemplary embodiment. The basic wiping operation is similar to that according to the first exemplary embodiment, and different points will be mainly described below.

FIG. 13A illustrates a state of the surface of the sheet 204 before the wiping. FIG. 13B illustrates a state after the first wiping performed in the Y direction (FIG. 13B arrow 215). FIG. 13C illustrates a state where the sheet 204 is fed immediately before the second wiping. FIG. 13D illustrates a state after completion of the second wiping performed in the Y direction (FIG. 13D arrow 215). The present exemplary embodiment differs from the first exemplary embodiment in that the wiping direction is different between the first and the second wiping. If the discharge port array having the maximum ink adhesion amount is different between the first and the second wiping, changing the wiping direction enables reducing the feed amount of the sheet 204 although the size of the ink adhesion region remains unchanged.

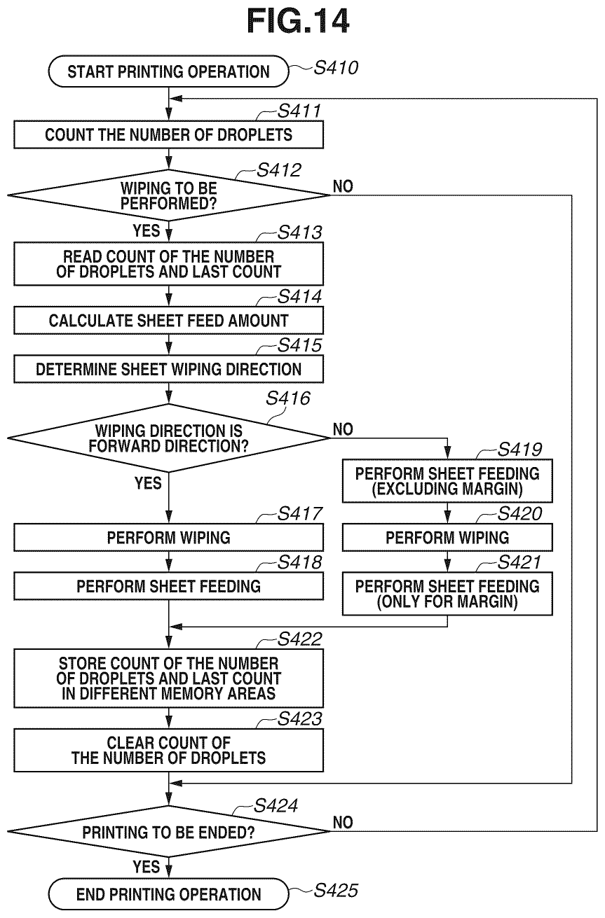

FIG. 14 is a flowchart illustrating the wiping operation. This flowchart is executed by the control unit 600 according to a program stored in the ROM 604. For example, the flowchart is started when the recording apparatus 10 receives a recording instruction from the user.

Operations in steps S410 to S412 are similar to those in steps S400 to S402 in FIG. 9. In step S413, the CPU 602 reads the last and the current counts of number of droplets. In step S414, the CPU 602 acquires a maximum ink adhesion amount for each array based on the counts of the number of droplets acquired in step S413, and calculates a sheet feed amount. The method for calculating the sheet feed amount is similar to that in step S405 in FIG. 9.

In step S415, the CPU 602 determines the wiping direction. There are two different wiping directions: forward direction and reverse direction. If the last wiping direction is the forward direction, and the discharge port array having been used to determine the sheet feed amount is different, the next wiping direction is the reverse direction. If the last wiping direction is the reverse direction, the next wiping direction is the forward direction irrespective of the discharge port array having been used to determine the sheet feed amount.

In step S416, the CPU 602 determines the wiping direction. If the wiping direction determined in step S415 is the reverse direction (NO in step S416), the processing proceeds to step S419. In step S419, the CPU 602 performs the sheet feeding based on the sheet feed amount excluding the margin. In step S420, the CPU 602 performs the wiping in the reverse direction. In step S421, the CPU 602 performs the sheet feeding for the margin.

If the wiping direction determined in step S415 is the forward direction (YES in step S416), the processing proceeds to step S417. In step S417, the CPU 602 performs the wiping. In step S418, the CPU 602 performs the sheet feeding based on the sheet feed amount including the margin.

When step S418 or S421 is completed, then in step S422, the CPU 602 separately stores the count of the number of droplets in a memory as the last count of the number of droplets. In step S423, the CPU 602 clears the current count of the number of droplets. In step S424, the CPU 602 determines whether printing is completed. If printing is not completed (NO in step S424), the processing returns to step S411. If printing is completed (YES in step S424), the processing proceeds to step S425. In step S425, the CPU 602 completes the print operation.

The CPU 602 calculates the actual feed amount based on the formulas in FIG. 10 and the table in FIG. 11. In a case of continuous printing, the numbers of droplets discharged immediately before the wiping are as follows: 2E4 for cyan, 4E4 for magenta, 1E4 for yellow, and 1E4 for black. The number of discharge ports is 512 for each array. Under an environmental temperature of 40° C. and an environmental humidity of 50%, the product of the liquid adhesion amount and the on-sheet spreading rate is maximized to 6.144 mm for magenta. With a margin of 1 mm, the sheet feed amount is obtained as 8.0 mm with a fraction rounded up. In a case of continuous printing after the wiping, the cumulative numbers of droplets discharged before the next wiping are as follows: 4E4 for cyan, 1E4 for magenta, 1E4 for yellow, and 1E4 for black. The number of discharge ports is 512 for each array. Under an environmental temperature of 40° C. and an environmental humidity of 50%, the product of the liquid adhesion amount and the on-sheet spreading rate is maximized to 2.048 mm for cyan. With a margin of 1 mm, the sheet feed amount is obtained as 4.0 mm with a fraction rounded up. The sum of the sheet feed amounts for the first and the second wiping is 12 mm. The colors used for the calculated sheet feed amounts are different: magenta in the first wiping and cyan in the second wiping. If different colors are used, the CPU 602 changes the wiping direction in the second wiping. Firstly, the CPU 602 sets the sheet feed amount before the second wiping. By using the counts of the number of droplets in the first and the second wiping, the CPU 602 obtains the sheet feed amount based on the value of the discharge port array having the maximum sum total of the sheet feed amounts for the first and the second wiping, with reference to the formulas in FIG. 10 and the table in FIG. 11. According to the exemplary embodiment, the cumulative number of droplets for the first and the second wiping are as follows: 6E4 for cyan, 5E4 for magenta, 2E4 for yellow, and 2E4 for black. The sum total of the required sheet feed amounts for the first and the second wiping are as follows: 5.0 mm for cyan, 4.0 mm for magenta, 6.0 mm for yellow, and 4.0 mm for black. Therefore, the CPU 602 performs the wiping and sheet feeding based on the sheet feed amount of 6.0 mm for yellow. Since the 3.0 mm sheet feeding is required in the second wiping for yellow, the CPU 602 first performs the sheet feeding by 3.0 mm. Then, the CPU 602 changes the wiping start position and the wiping direction, and then performs the wiping. Then, the width of the sheet 204 used in the first and the second wiping is 6.0 mm. This enables saving the amount of sheet usage in comparison with a case of the same wiping direction in the first and the second wiping.

Thus, the feed amount of the sheet 204 is determined by using the count of the number of droplets before wiping, so that the sheet feed amount can be changed for each wiping. This enables a constant setting of a clean sheet surface at the wiping position without an increase of the unused region of the sheet 204. The present exemplary embodiment makes it possible to, through wiping, remove the ink adhesion to the discharge port surface which may cause a discharge failure, and to reduce the amount of sheet usage.

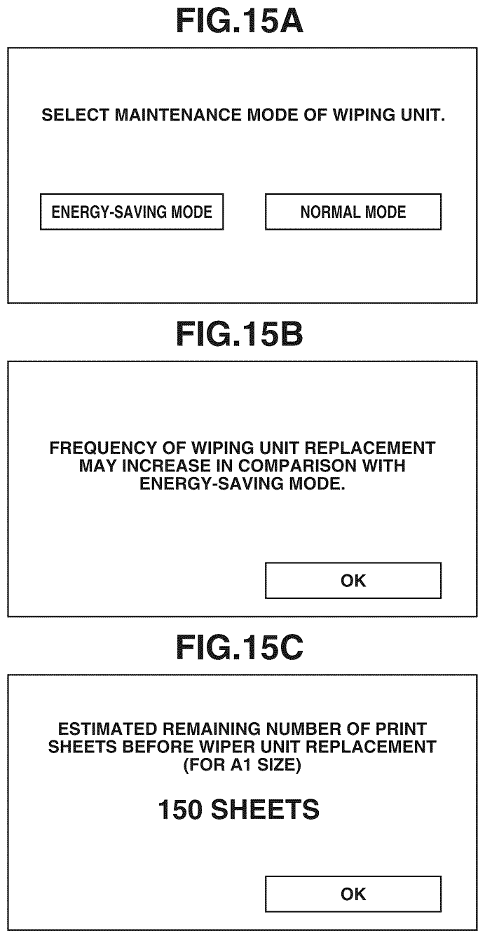

A third exemplary embodiment of the present disclosure will be described below. FIGS. 15A to 15C illustrate a third exemplary embodiment.

FIG. 15A illustrates panel screens related to a wiping setting. The user can set either the “energy-saving mode” or the “normal mode”. To change the setting, the user displays the screen in FIG. 15A and selects a setting again. The mode in which the wiping is performed with the method according to the first or the second exemplary embodiment is referred to as the “energy-saving mode”, and the mode in which the wiping is performed with the method according to the comparative example in FIG. 13A is referred to as the “normal mode”. The method according to the comparative example in FIG. 13B is not used since the method may possibly perform the wiping in a state where ink on the sheet 204 adheres to the discharge port surface of the recording head 200. The “energy-saving mode” is characterized in that the amount of sheet usage can be reduced. The “normal mode” is characterized in that the time required to calculate the sheet feed amount can be reduced.

FIG. 15B illustrates a screen displayed when the “normal mode” is selected in FIG. 15A. This screen notifies the user that the frequency of the replacement of the wiping unit 203 may possibly increase in comparison with a case where the “energy-saving mode” is selected. The screen allows the user to select a mode after the user has recognized the maintainability of the wiping unit 203.

FIG. 15C illustrates a screen displayed when either the “energy-saving mode” or the “normal mode” is selected. The screen displays the estimated remaining number of print sheets before the replacement of the wiping unit 203. Notifying the user of the remaining number of print sheets before the replacement allows the user to purchase replacement parts without delay.

Further, the CPU 602 may prompt the user to prepare replacement parts of the wiping unit 203 when the estimated remaining number of print sheet became less than a predetermined value. The CPU 602 calculates the estimated remaining number of print sheets by subtracting the cumulative sheet feed amount from the total length of the sheet 204, dividing the result by the sheet feed amount setting in the normal mode to calculate the remaining number of wiping operations, and multiplying the result by the number of print sheets for each wiping operation. The above-described division by the sheet feed amount setting in the normal mode is performed because it is difficult to estimate the sheet feed amount in the energy-saving mode since the feed amount depends on situation. Therefore, the user can set the energy-saving mode in which the sheet feed amount can be adjusted for each wiping. When the energy-saving mode is selected, the present exemplary embodiment makes it possible to, through wiping, remove the ink adhesion to the discharge port surface which may cause a discharge failure, and to reduce the amount of sheet usage.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-141712, which was filed on Aug. 31, 2023 and which is hereby incorporated by reference herein in its entirety.

What is claimed is:

1. A recording apparatus comprising:
a recording unit having a discharge port surface having a plurality of discharge port arrays each including a plurality of discharge ports for discharging ink;
a wiping unit including a sheet-like wiping member for wiping the discharge port surface, and configured to wipe the discharge port surface;
at least one memory storing instructions; and
at least one processor that is in communication with the at least one memory and that, when executing the instructions, cooperates with the at least one memory to
perform control to relatively move the wiping unit and the recording unit in an arrangement direction of the discharge port arrays, cause the wiping unit to perform a wiping operation for wiping the discharge port surface, and then cause the wiping unit to feed the wiping member to enable wiping with a new region of the wiping member in a next wiping operation,
acquire information about a discharge amount for each discharge port array, and
determine a feed amount for feeding the wiping member after the wiping operation, based on the information about the discharge amount.

2. The recording apparatus according to claim 1, wherein, when executing the instructions, the at least one processor further cooperates with the at least one memory to determine the feed amount after the wiping operation, based on a formula or a table for associating the information about the discharge amount with a size of an ink adhesion region on the wiping member.

3. The recording apparatus according to claim 2, wherein, when executing the instructions, the at least one processor further cooperates with the at least one memory to derive the size of the ink adhesion region on the wiping member by using the formula or the table for associating the information about the discharge amount with the size of the ink adhesion region on the wiping member, and determine the feed amount after the wiping operation based on the derived size of the ink adhesion region.

4. The recording apparatus according to claim 3, wherein the feed amount is larger than the size of the ink adhesion region on the wiping member.

5. The recording apparatus according to claim 1, wherein an operation for feeding the wiping member is performed immediately after the wiping operation.

6. The recording apparatus according to claim 1, wherein an operation for feeding the wiping member is performed immediately before the wiping operation.

7. The recording apparatus according to claim 1, wherein the information about the discharge amount is information about a discharge amount after a last wiping operation.

8. The recording apparatus according to claim 7, wherein the information about the discharge amount is the number of droplets.

9. The recording apparatus according to claim 7, wherein the feed amount after the wiping operation is determined based on information about the discharge amount of the discharge port array having the largest discharge amount out of the plurality of pieces of information about the respective discharge amount.

10. The recording apparatus according to claim 9, wherein, when executing the instructions, the at least one processor further cooperates with the at least one memory to, in a case where the discharge port array having the largest discharge amount in the information is different from a discharge port array having the largest discharge amount in information acquired in a last wiping operation, cause the wiping unit to perform the wiping operation to wipe the recording unit in a direction opposite to a direction of the wiping operation for the recording unit in the last wiping operation.

11. The recording apparatus according to claim 10, wherein, when executing the instructions, the at least one processor further cooperates with the at least one memory to, in a case where the discharge port array having the largest discharge amount in the information is different from the discharge port array having the largest discharge amount in the information acquired in the last wiping operation, control the wiping unit so that the sheet feed amount after the wiping operation is smaller than that in a case where the discharge port array having the largest discharge amount in the information is identical to the discharge port array having the largest discharge amount in the information acquired in the last wiping operation.

12. The recording apparatus according to claim 1,
wherein the recording unit is configured to discharge ink of a plurality of colors, and
wherein, when executing the instructions, the at least one processor further cooperates with the at least one memory to change the feed amount for each ink color even with the same information about the discharge amount.

13. The recording apparatus according to claim 1, wherein, when executing the instructions, the at least one processor further cooperates with the at least one memory to change the feed amount according to time from a discharge of ink to execution of the wiping operation.

14. The recording apparatus according to claim 1, wherein the feed amount is changed according to a temperature and a humidity in a surrounding environment.

15. The recording apparatus according to claim 1, wherein either an energy-saving mode or a normal mode is settable to a setting for the wiping operation.

16. The recording apparatus according to claim 15, wherein, in a case where a user selects the normal mode, a possibility that a frequency of replacement of the wiping member increases is notified.

17. The recording apparatus according to claim 16, wherein an estimated remaining number of print sheets before replacement of the wiping member is notified.

18. The recording apparatus according to claim 17, wherein the estimated remaining number of print sheets is calculated based on a cumulative value of the feed amounts.

19. The recording apparatus according to claim 18, wherein the estimated remaining number of print sheets is calculated by subtracting the cumulative value of the feed amounts from a total length of the wiping member, dividing a result by a setting value of a feed amount for the normal mode to calculate a remaining number of the wiping operations, and multiplying the remaining number of the wiping operations by the number of print sheets for each wiping operation.

20. A wiping method comprising:
wiping in which a recording unit, having a discharge port surface having a plurality of discharge port arrays each including a plurality of discharge ports for discharging ink, and a wiping unit, provided with a sheet-like wiping member for wiping the discharge port surface and configured to wipe the discharge port surface, are relatively moved in an arrangement direction of the discharge port arrays and the wiping unit is caused to perform a wiping operation for wiping the discharge port surface;
performing, after the wiping, feeding by controlling the wiping unit to feed the wiping member to enable wiping with a new region of the wiping member in a next wiping operation;
acquiring information about a discharge amount for each discharge port array; and
determining a feed amount for feeding the wiping member after the wiping operation based on the information about the discharge amount acquired in the acquiring,
wherein, in the feeding, the wiping member is fed by the feed amount determined in the determining.
